(19) United States
(12) Patent Application Publication
(10) Pub. No.: US 2019/0317004 A1
(43) Pub. Date: Oct. 17, 2019

(54) IMAGING APPARATUS AND METHODS

(71) Applicant: UNIVERSITY OF SALFORD, Salford (GB)

(72) Inventors: Miklas SCHOLZ, Salford (GB); Apostolos ANTONACOPOULOS, Salford (GB); Christian CLAUSNER, Salford (GB); Suhad ALMUKTAR, Salford (GB)

(73) Assignee: UNIVERSITY OF SALFORD, Salford (GB)

(21) Appl. No.: 16/347,850

(22) PCT Filed: Nov. 7, 2017
(86) PCT No.: PCT/GB2017/053332

§ 371 Date: May 7, 2019

(30) Foreign Application Priority Data
Nov. 8, 2016 (GB) 1618812.0

(51) Int. Cl. G01N 15/06; C02F 11/12; G01N 21/75; G01N 13/00; G01N 21/85

(52) U.S. Cl. CPC G01N 15/0618; C02F 11/12; G01N 21/85; G01N 13/00; G01N 21/75

(57) ABSTRACT

An apparatus for determining the values of one or more characteristics of a liquid that has support means for supporting a filter member in use, a reservoir for holding a sample of liquid in direct or indirect contact with the filter member in use and at least one device operable to record one or more images of the filter member and/or liquid to record the value of one or more characteristics of a liquid moving through the filter member in use.

### TECHNICAL FIELD OF THE INVENTION

The present invention relates to improvements in or relating to imaging apparatus and methods for calculating one or more characteristics of a liquid, specifically a liquid flowing through or across a filter member.

### BACKGROUND TO THE INVENTION

It is known in the art that the “dewaterability” of a liquid may be estimated using a capillary suction time (CST) test. “Dewaterability” can be defined as the propensity or ability of a suspension of solids in a liquid to be filtered to provide a solids-free or reduced solid liquid. The capillary suction time and the resistance to filtration (not automated laboratory procedure) tests are currently the standard tests used in the sludge and sewage dewatering units of the water and wastewater industry. The CST test provides an estimate for the dewaterability of sludge and sewage, indicating the filterability after the addition of coagulant aids (optional). Dewatering of sludge is essential when transport or disposal, and particularly incineration, is required. Whilst the current CST test is simple to conduct, the minimal data collection points produce results with varying levels of accuracy and reliability. Many potentially useful characteristics of the liquid cannot be determined with the CST test and the apparatus and method offers limited flexibility causing severe difficulties in testing certain liquids. GB1161792 describes a CST apparatus and method in which the time taken for a liquid to travel through a filter paper is determined, and in particular this may be determined with the naked eye or via calculation of the resistance of a suspension to filtration.

Consideration must be given to the reliability of results, ease-of-use, time to produce results and also flexibility of the apparatus and method concerning the use of different liquids. It would be desirable to have access to an apparatus and method that maximises ease-of-use, reliability and accuracy of results whilst minimising the standard error and time taken to conduct the test.

It would therefore be desirable to provide an apparatus and method that can produce estimation values with improved accuracy, higher reliability and greater flexibility for the testing of a wider range of liquids, without increasing the time taken to calculate the estimation values.

It is therefore the aim of embodiments of the invention to provide an apparatus and method which overcomes or at least partially mitigates the problems associated with the prior art.

### SUMMARY OF THE INVENTION

According to a first aspect of the present invention there is provided an apparatus for determining the value of one or more characteristics of a liquid, comprising support means for supporting a filter member in use, a reservoir for holding a sample of liquid in contact with the filter member in use and at least one device operable to record one or more images of the filter member and/or liquid, to record the value of one or more characteristics of a liquid moving through the filter member in use.

In this way, the configuration of the apparatus provides a means to record one or more images of the filter member and/or the liquid tested, wherein the image or images recorded can be analysed to deduce the value of one or more characteristics of the liquid moving through the filter member. Previous apparatus configurations have required either human measurement or had limited measurement points (such as electrodes) to record data relating to the liquid moving through the filter member.

The CST method described hereinabove has generally involved the use of electrodes to record the time taken for the liquid to travel a known distance radially from the centrally placed reservoir or has only used the naked eye to track movement. Visual image recording offers a far more flexible solution, allowing for parameters to be measured and/or calculated at a greater, and theoretically infinite, number of data points resulting in improved reliability of results. The use of one or more devices operable to record one or more images (which hereinafter may be referred to as “imaging device” or “imaging devices”) may produce results in less time than the current testing apparatus, with a lower standard error and may also allow a greater number of characteristics of the liquid to be calculated.

The characteristic or characteristics of the liquid recorded may, for example, include any number of, but not limited to, velocity; acceleration; displacement; deceleration; variation in speed over defined time periods; turbidity; colour change; light transmission; light absorption; light reflectiveness, distance moved per unit time; or location of the liquid front. Each characteristic may be recorded at one or more locations within the field of view of the device operable to record one or more images. Data points may be recorded at, for example, 1, 2, 3, 4, 5, 6, 7, 8, 9, or 10 locations, or up to 20 locations, or up to 100 locations, or up to 500 locations, or over 500 locations. Alternatively, data collected by the (or each) device may not be at discrete locations, but may be recorded over a region.

Data recorded by the or each imaging device may comprise the location of a liquid front moving through the filter member. The or each imaging device may collect data at defined locations, when the liquid front reaches said locations, or the imaging device may ‘follow’ the liquid front and record data at, for example, defined or random time intervals. The or each imaging device may record an image of the whole of the liquid front, the whole of the leading edge of the liquid front or a part thereof.

In some embodiments more than one device operable to record one or more images may be used; for example, 1, 2, 3, 4 or 5 devices may be used, or up to 10 devices may be used, or 10 or more device may be used. Each device may or may not be set-up to record the same field of view, a different field of view or overlapping fields of view.

The field of view of the one or more devices operable to record one or more images of the filter member and/or liquid may or may not contain 100% of the surface area of the filter member. The field of view for each device, independently, may contain at least 30%, or at least 40%, or at least 50%, or at least 60%, or at least 70%, or at least 80%, or at least 90%, or 100% of the surface area of the filter member. The device or devices operable to record one or more images of the filter member and/or liquid may have zoom capability, allowing for alteration of the area contained within the field of view without adjusting the physical location of the device or devices.

The characteristic or characteristics of the liquid may be recorded at one or more moments in time during use by the device or devices operable to record one or more images, wherein data may be recorded at least 60 times per second, or at least 30 times per seconds, or at least 15 times per second, or at least once every second, or at least once every 5 seconds, or at least once every 10 seconds, or at least once every 30 seconds, or at least once every minute, or at least once every 5 minutes.

The device or devices operable to record one or more images may be positioned at any location above or below the filter member that allows the field of view to contain a portion of the filter member, in use. The device or devices will preferably be positioned so that the line of sight of the or each device is substantially perpendicular to the filter member and/or liquid, and so that the line of sight passes within the edges of the filter member in use.

In some embodiments the support means for supporting a filter member may comprise a baseplate with an upper surface, preferably a planar upper surface; and which may have perimeter dimensions equal to, or preferably larger than the filter member that is to be used. The width of the baseplate may be less than or equal to 10 mm, or at least 10 mm, or at least 20 mm, or at least 50 mm, or at least 100 mm, or at least 500 mm. The preferred width of the baseplate is between 20 mm and 100 mm. The length of the baseplate may be less than or equal to 10 mm, or at least 10 mm, or at least 20 mm, or at least 50 mm, or at least 100 mm, or at least 500 mm. The baseplate length may be between 50 and 200 mm. In some embodiments, the height of the filter member support means may be up to 2 mm, or up to 5 mm, or up to 10 mm, or up to 20 mm, or up to 50 mm, or up to 100 mm. The height of the filter paper support means is preferably between 2 mm and 50 mm. In other embodiments the support means for supporting a filter member may comprise a tray or open container such as a baseplate with a raised lip around the uppermost edges, creating a tray-like shape. In such embodiments, the filter member may be better secured in place, and liquid may be contained and disposed of relatively easily. Furthermore, a higher reliability of measurements can be achieved.

In some embodiments, the upper surface of the support means may be made of any suitable material, preferably a non-porous and substantially flat material. In some embodiments, the material is a plastics or polymer material, and may be a chemically unreactive plastic or polymer material to minimise weight and reduce the chances of a chemical reaction between the surface of the support means and the liquid in use. Suitable plastic or polymer materials include polyester, polyamide, polystyrene or the like, for example. In other embodiments, the support means may comprise metal or alloy such as steel or aluminium, for example, or glass or ceramic material.

In some embodiments, the baseplate acting as a support means for the filter member may lie on top of a support body. In some embodiments, this support body may have top surface dimensions of any size, preferably equal to or larger than those of the baseplate. The support body may have a height dimension of less than or equal to 10 mm, or up to 20 mm, or up to 50 mm, or up to 100 mm, or up to 200 mm, or up to 500 mm. In some embodiments, the support body may be mounted on one or more legs. The support body may be made of any material, such as plastics, metal or alloy, for example.

In some embodiments, the filter member may be a porous or fibrous material, preferably in the form of a sheet. This may be, but is not limited to paper filters, cellulose filters, glass microfiber filters, nylon membranes, polyamide membranes or polypropylene membranes. The filter member is preferably a sheet of filter paper and may be either untreated, chemically modified or purified. The length and width of the filter member may be of any dimensions, preferably smaller than the outer dimensions of the upper surface of the support means. The height of the filter member, in use, may be up to, for example, 0.1 mm, or up to 1 mm, or up to 5 mm, or up to 10 mm, or up to 20 mm or up to 50 mm, for example.

The support means (and support body, when present) may be positioned so that the filter member is maintained at any suitable orientation. The support means will preferably maintain the filter member in a substantially horizontal position to prevent or mitigate gravitational force affecting the movement of liquid in use.

The liquid may be selected from gels, water, sludge or any liquid that may contain particles, suspended solids and/or colloidal matter. Industrial wastewaters, sludges and sewage are examples of liquids for which the apparatus of the invention can be used.

In some embodiments, the reservoir may releasably hold the liquid until it is required for the liquid to contact the filter member. The reservoir may be of any suitable shape. The reservoir may be constructed of any material such as a non-porous polymer or plastics material. The reservoir may comprise a liquid inlet and a liquid outlet. The reservoir may comprise a container with an inlet such as in the form of an upper opening, and an outlet such as in the form of a lower opening. A liquid may be transferred into the reservoir by means of the inlet. A liquid may be arranged to make contact with the filter member by means of the outlet. The liquid may be retained in the reservoir until required for use, and the reservoir may comprise means to enable release of the liquid at any desired velocity out of the reservoir, such as via a flow valve, gate or other suitable devices.

The reservoir may comprise an outlet which is arranged to contact the filter member, in use.

The outlet may comprise a linear slot or aperture, which in use enables expulsion of a liquid with a substantially linear moving liquid front (leading edge).

In some embodiments, the reservoir may have a capacity of less than or equal to 1 ml, or at least 1 ml, 2 ml, 3 ml, 4 ml, 5 ml, 6 ml, 7 ml, 8 ml, 9 ml, or 10 ml or at least 15 ml, 20 ml, 30 ml, 40 ml, 50 ml, 75 ml, 100 ml, 150 ml, 200 ml, 250 ml, 500 ml, 750 or 1000 ml. In some embodiments the capacity is between 10 ml and 200 ml. The height of the reservoir may be of any suitable dimension, and arrangements may be made to keep the reservoir level stable allowing for a constant liquid head.

The reservoir may be positioned at any location in operable connection with the upper surface of the filter member in use. The location of the reservoir may be central, or at any location between the centre of the filter member and one or more edges of the device. In some embodiments, the reservoir is positioned towards, adjacent to and/or parallel to an edge of the device. The outlet of the reservoir may be located in a position which in use is arranged above an area of a filter member connected to the apparatus. At least part of the reservoir or reservoir outlet may be located in a position towards or adjacent to an edge of a connected filter member. Liquid may therefore be ejected from the reservoir and contact the filter member towards or adjacent said edge. The outlet of the reservoir may eject liquid in a manner which creates a substantially linear moving liquid front (leading edge), which travels through the filter member, starting at or near one edge of the filter member and which travels away from the said edge. A barrier may be placed around the reservoir to prevent a liquid front advancing across the filter member in an undesired direction.

In some embodiments, the reservoir may be permanently fixed in one location on or above the support means and/or the reservoir may be movable to multiple locations on or above the support means.

The apparatus may comprise a filter member, which may be detachable and/or replaceable. The position of the filter member may be manually adjustable, whilst the reservoir is in place. The filter member may be attached to the apparatus whilst the reservoir is fixed in place or before the reservoir is fixed in place. The reservoir may be positioned at any height above the support means, and the height of the reservoir above the support means may be adjustable. The bottom edges of the reservoir may be in contact with the surface of the filter member in use. The reservoir may be secured in place by mechanical or chemical means, such as by welding, connectors or adhesives, for example.

In some embodiments the or each device operable to record one or more images of the filter member and/or liquid may comprise an optical imaging device; infrared imaging device; magnetic resonance imaging device and computed tomography device. Optical imaging devices may include cameras, which may be of any suitable type. The recorded image or images may be analysed with the use of software and the process of calculating one or more characteristics of the liquid may be automated. In the preferred embodiment, any device operable to record an image or images within the visible light spectrum may be used, and may be a standard still or video camera.

In some embodiments, the device operable to record one or more images of the filter member and/or liquid may be secured to a structure that is located above the filter member. The means of securing the device operable to record one or more images of the filter member and/or liquid to the structure may be mechanical, which may comprise a means to attach and detach the device to the apparatus. In some embodiments, the structure to which the imaging device is connected may be positioned over part or the entirety of the support means. The structure may form a lid or cover over the filter member, support means and reservoir. By securing the device to a stable lid or cover, the image quality may be improved by positioning the device in a way that allows less movement or vibration during transport and use.

In other embodiments, there may be a separate lid or cover in addition to or alternative to the structure holding the imaging device.

In some embodiments, any lid or cover, or the structure holding the imaging device located above the filter member may be attached to the support means by means of a hinge or articulate joint. This allows opening and closing of the apparatus to give access to the internal components including the filter member and reservoir when open, and in the case of a lid or cover being part of a structure holding the imaging device, to position the imaging device operable to record one or more images of the filter member and/or liquid when closed. In other embodiments, the lid, cover or structure may be connected to the support means by means of connecting pins, magnets or any other method that may assist in locating the lid, cover or structure into position. In other embodiments, the means of connection may be situated on the outside surface of the apparatus.

In some embodiments, the lid, cover or structure holding the imaging device may include a pipe or conduit that provides access to the reservoir when the lid, cover or structure holding the imaging device is positioned for use. In some embodiments, this pipe or conduit may be of any shape, and it may be connected to the top of the reservoir. The pipe or conduit may be connected to an inlet of the reservoir or may form or comprise an inlet. The pipe or conduit may be detachable between uses and/or during use of the apparatus. The top of the pipe or conduit may, for example, sit flush with the upper surface of the lid, cover or structure holding the imaging device or may protrude above it. In one embodiment, the pipe or conduit may be situated so that it does not make contact with the reservoir when the lid, cover or structure holding the imaging device is moved between an open and closed position.

In some embodiments, multiple devices operable to record one or more images of the filter member and/or liquid may be used. The use of a particular number of devices will be determined by factors including, but not limited to size of the filter member, positioning of the reservoir above the filter member, and quantity of data points required. If more than one device is used, the devices may be situated, for example, linearly, radially or concentrically with respect to each other. The data recorded by the one or more devices may be analysed independently to produce one or more values for the one or more characteristics of the liquid from each individual device, or the data sets from two or more devices may be analysed synchronously by means of an algorithm such as, for example, direct linear transformation in order to produce values calculated using data sets from more than one device. Each device may record the same and/or different characteristics of a liquid.

In some embodiments, the support means comprise a light source, which may be integral with or connected to the support means. This may be used to improve the clarity of images recorded. In some embodiments, a single light source may be used, or there may be more than one light source. The light source may be, for example, a neon light, fluorescent light, halogen light, ultraviolet light, infrared light or light emitting diode for example. In some embodiments, the means of support for the filter member may be translucent or transparent, or may comprise a hollow member or a framework, which allows transmission of light therethrough.

In some embodiments, the device or devices operable to record one or more images of the filter member and/or liquid may be operably connected to a computer or other electronic computing device. This may be by means of a direct physical connection, or by means of a connecting device such as a USB hub. In other embodiments, the data from the device or devices operable to record one or more images of the filter member and/or liquid may be transferred to the computer or other electronic computing device via a wireless connection. In some embodiments, multiple computer or electronic computing devices may be connected. Examples of electronic computing devices may include mobile telephones, tablets, laptop computers and the like.

The apparatus may include one or more further electronic devices such as an additional device to monitor one or more characteristics of a liquid or the filter member. The (or each) additional device may comprise, for example, a motion sensor, an electrode, a turbidity sensor or a spectrometer or the like. Furthermore, the device may contain a liquid stirring or agitation means to avoid settlement of particles and/or suspended solids and/or temperature, humidity and/or pressure control elements.

In some embodiments, a USB hub is connected to the lid, cover or structure holding the imaging device. The USB hub may be situated remotely from the apparatus and is not required to be attached to a lid or cover in use. A USB hub or port, or similar computer connection means, allows for the computer or any other connected electronic computing device to be situated remotely from the apparatus, which may minimise the risk of contact between the computer or other electronic computing devices and any liquid.

According to a second aspect of the present invention, there is provided a method for determining the value of one or more characteristics of a liquid, wherein the method comprises the steps of a) placing a sample of liquid in contact with a filter member to create an advancing liquid front through the filter member; b) imaging the advancing liquid; and c) using the or each image to record the value of one or more characteristics of the liquid.

In this way, the method provides a way to determine a value or values of one or more characteristics of a liquid with relatively high reliability, flexibility and speed than current comparable methods.

In some embodiments, the liquid may be held in contact with the filter member in a reservoir. Liquid may enter the reservoir via an upper opening, and may make contact with the filter paper via a lower opening. Preferably the reservoir will not move during use, and so the contact area between the liquid and filter member may remain constant in use.

The method may be performed using an apparatus of the first aspect of the invention.

Step b) may comprise imaging the advancing liquid with one or more devices operable to record one or more images of the filter member and/or liquid, which device(s) may be as described for the first aspect of the invention. The or each device may be an optical imaging device such as a camera, for example.

The filter member may be as described for the first aspect of the invention.

The method may comprise covering the filter member with a lid or cover, which may be performed before step b).

The method may comprise attaching one or more imaging devices to a structure of the apparatus and placing the structure above the filter member or a part thereof. The structure may comprise a lid or cover.

Liquid may enter the reservoir with or without a lid, cover or structure holding the imaging device in place. When a lid, cover or structure is in place, the use of a conduit or pipe extending through the lid, cover or structure to transfer liquid into the reservoir may be required. In some embodiments, a reservoir lid may be provided to help prevent liquid from spilling out of the reservoir. In one embodiment liquid enters the reservoir through the conduit or pipe when the lid is closed. The apparatus may contain a device to keep the liquid level stable.

This embodiment may assist in ensuring the device or devices operable to record one or more images of the filter member and/or liquid is/are in the correct position/positions to record an image or images in use. In some embodiments, as the liquid enters the reservoir and makes contact with the filter member, an advancing liquid front may be created. This liquid front may be of any shape or size, and travel at any possible velocity (including zero velocity). The shape and dimensions of the reservoir and its filling level may affect the shape and velocity of the liquid front, and this may be purposely modified for varying test scenarios. The movement of the liquid front across the filter member may or may not be restricted by any physical means in order to, for example, affect the direction, size, speed or shape of the liquid front.

In some embodiments, step a) may comprise creating a substantially linear advancing liquid front. Step b) may comprise taking one or more images of at least part of the leading edge of the advancing liquid front and/or one or more images of a trailing portion of the advancing liquid front.

In some embodiments, the device or devices operable to record one or more images of the filter member and/or liquid may record one or more images of the filter member and/or liquid over any suitable time period. Data collection from the device or devices may begin, for example, before liquid enters the reservoir, as liquid enters the reservoir, as the liquid front enters the device or devices field of view or at any other time during use. The device or devices may record data, for example, for a set period of time, until a set quantity of data has been collected or for any other duration. The start and end of data collection maybe, for example, controlled manually, automatically or by any combination of manual and automatic control.

The or each imaging device may record images of the filter member and/or liquid at defined time periods during movement of the liquid through the filter member at random time periods or at a combination of defined and random time periods. Alternatively, images may be recorded continually or continuously. The or each device may record at least part of the position of the leading edge of the liquid front as the liquid moves through the filter member. The or each imaging device may record images of any part of the advancing liquid and may record, for example, the same area of the filter member either continuously, or at defined time periods to determine the drying rate or level of evaporation over time; for example. In embodiments, where there are two or more imaging devices, each device may record images independently, and each device may record images at the same defined time periods or at different time periods. For example, in embodiments, where there are two or more devices recording images of different areas of the filter member or liquid, the devices may record sequential images over time.

In some embodiments, the data recorded by the device or devices operable to record one or more images of the filter member and/or liquid may be transferred automatically to a connected computer or other electronic computing device or devices. In some embodiments, data recorded may be automatically processed before being transferred to a connected device or devices.

In some embodiments, data transferred to a connected device or devices may be automatically analysed to produce a value or values of the characteristic or characteristics of the liquid. The analysis of data preferably does not require human intervention. Preferably data analysis will be an automated process, which may result in one or more values for one or more characteristics of the liquid being generated more quickly, reliably and comprehensively than it is possible with the current CST test.

In some embodiments, data analysis may be conducted on one or more electronic computing devices. In some embodiments, calculation of one or more different values for one or more different characteristics may be on separate devices, or display of one or more results in different formats may be on different devices.

In some embodiments, image analysis software may be installed on the computer or computing devices, which may enable automated data analysis of the recorded image data with minimal human involvement. In such embodiments, the automated data analysis software may be configured to automatically produce values and/or visual data representations such as figures and tables for any combination of the liquid characteristics possible.

According to a third aspect of the invention there is provided a method of the second aspect of the invention using an apparatus of the first aspect of the invention.

According to a fourth aspect of the invention this is provided use of the apparatus of the first aspect of the invention to measure at least one characteristic of a liquid to be tested.

### DETAILED DESCRIPTION OF THE INVENTION

In order that the invention may be more clearly understood, embodiments thereof will now be described, by way of example only, with reference to the accompanying drawings, of which:

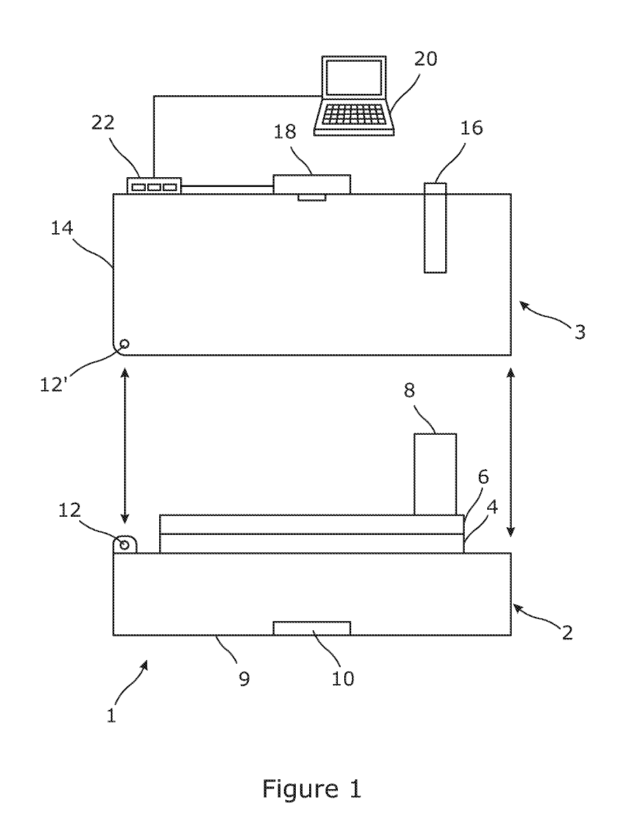

FIG. 1 is aside view of an embodiment of the apparatus of the present invention with upper and lower sections separated;

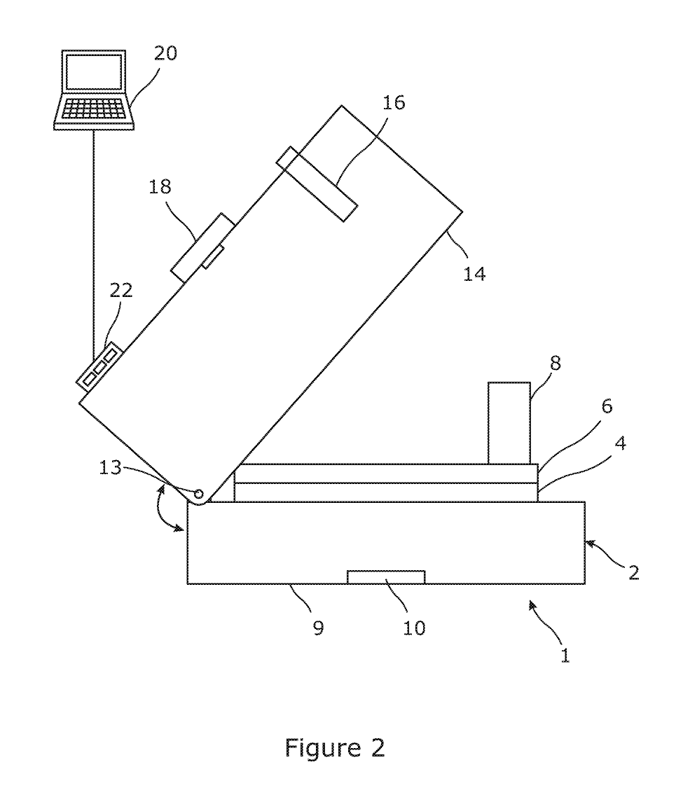

FIG. 2 is a side view of the embodiment shown in FIG. 1 with connected upper and lower sections;

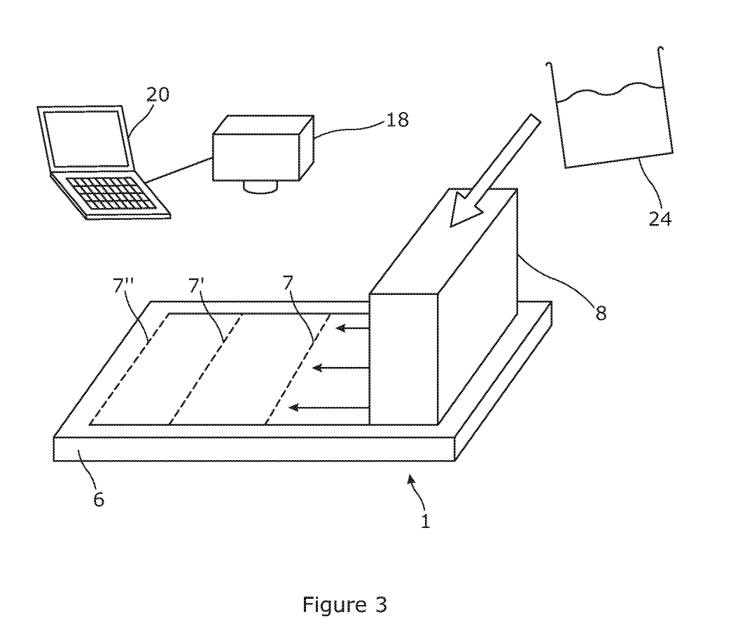

FIG. 3 is a perspective view of a schematic of the apparatus of FIGS. 1 and 2 in use during an embodiment of the method of the invention (with the upper section removed).

FIGS. 1 and 2 illustrate an embodiment of the apparatus in accordance with the present invention. The apparatus 1 includes a bottom section (2) containing a base (9), a support means (4), a filter member (6), a reservoir (8), a light source (10) and part of a connection hinge joint (12).

The apparatus also includes a top section (3). The top section (3) comprises a cover structure (14) to which is mounted, a device operable to record one or more images of the filter member (6) and/or liquid in the form of an imaging camera (18). The imaging camera (18) is connected to a USB hub (22), which is in turn connected to a laptop computer (20). The cover structure (14) also includes a conduit in the form of a pipe (16), which extends into and protrudes above the cover structure (14).

The bottom section (2) is connected to a top section (3), via a hinge (12) on the bottom section (2) and a hinge (12′) on the top section (3), which together forms a hinge joint (13) as shown in FIG. 2.

The support means (4) in the form of a tray is situated above the base (9). The base (9) comprises a body with a cut out section in the lower most surface. The support means (4) is fixed in place on the base (9) and is connected by mechanical means such as pins or clips, or by chemical means such as an adhesive connection. In the embodiment as shown in FIGS. 1 and 2, the support means (4) is connected to the uppermost surface of the base (9). The support means (4) may be detachable from the base (9) in order to, for example, clean the surface or attach a filter member (6). In the embodiment shown in FIGS. 1 and 2, the dimensions of the support means (4) are smaller than the base (9). The base (9) is a hollow member, while the support means (4) is a transparent sheet comprising plastics or glass.

The filter member (6), as shown in FIGS. 1 and 2, is positioned on top of the support means (4). In use, the filter member (6) may be temporarily secured in place by mechanical means such as clips or a clamping mechanism. In the embodiment illustrated in FIGS. 1 and 2, the filter member (6) has the same length as the support means (4). In other embodiments, a filter member (6) with smaller outer dimensions than the support means (4) may be used, and may aid in containing excess fluid, without affecting any results generated from the use of the apparatus (1).

The reservoir (8) is situated above the surface of the filter member (6) as shown in FIGS. 1 and 2. The reservoir (8) is positioned towards the right hand side, parallel with and close to the edge of the filter member (6). This allows for a large percentage of the filter member (6) to be covered by a single advancing liquid front, if the device is in use. The reservoir (8) is placed on top of the filter member (6) after it is correctly aligned at the desired portion of the filter member (6).

The light source (10) is situated beneath the filter member (6) and the support means (4). The light source is located in a cut out at the underside of the base (2). As the base (9) is hollow and the support means (4) is transparent, light emitted from the light source (10) illuminates the underside of the filter member (6), if the innovation is in use. In alternative embodiments, the base (9) may be formed from a solid and transparent (or translucent) material, for example.

The hinge joint (13) mechanically connects the bottom section (2) and the top section (3) together, and consists of hinge components (12) and (12′) located in the bottom section (2) and top section (3), respectively. The hinge joint (13) allows the top section (3) to rotate through one axis about the hinge joint (13). FIG. 2 illustrates the apparatus with the top section (3) and bottom section (2) connected at the hinge joint (13) and the top section (3) rotated into an open position. This mechanism allows the imaging camera (18) to be temporarily removed to allow easy access to the inner body of the apparatus comprising amongst other components the filter member (6) and reservoir (8), and then returned to exactly the same position with minimum effort.

The top section (3) consists of the cover structure (14), the pipe (16) and the imaging camera (18). Also shown in FIGS. 1 and 2 are the laptop (20) and the connection means in the form of a USB hub (22). The laptop (20), as shown, is not situated in direct contact with the apparatus (1) but is remotely connected.

The pipe (16) is fixed in place within the cover structure (14) and protrudes from the upper surface thereof. The pipe (16) may be secured in place by chemical, magnetic or mechanical means and this connection may be permanent or temporary. The pipe (16) is located in the cover structure (14) in a position that allows rotation about the connection (13) without contact between the pipe (16) and the reservoir (8).

The imaging camera (18) is situated on the top surface of the cover structure (14) and is fixed in position. The imaging camera (18) is fixed securely but adjustably in place, and is situated in the cover (14) in a location that maximises the field of view coverage. In this embodiment, it is shown that the imaging camera (18) is positioned in a central location above the filter member (6), if the cover (14) is in the closed position.

The connection means between the imaging camera (18) and the laptop (20) in this embodiment is via a USB hub (22) and is fixed in place on the top cover structure (14). The USB hub may be secured in place by mechanical means or with the use of a chemical adhesive.

As shown in FIGS. 1 and 2, the laptop (20) is remotely connected to the apparatus (1). This is the preferred embodiment to reduce the risk of contact between the laptop and the liquid. The length of connecting cables between the apparatus (1) and the laptop (20) should be minimised to reduce noise, or alternatively the laptop (20) may be wirelessly connected to the imaging camera (18).

The operational use of the apparatus (1) will now be described with reference to the Figures. In use, the top cover (14) is rotated between an open position, as shown in FIG. 2, and a closed position. When in the open position (FIG. 2), the internal components of the bottom section (2) such as the support means (4), the filter member (6) and the reservoir (8) are all accessible. In use, this allows for the filter member (6) to be positioned correctly and then removed after use without obstruction from components of the top section (3). The top section (3) is rotated about the connection (13) into the closed position before use to position the imaging camera (18) correctly to conduct a test. In the closed position, the top section (3) and bottom section (2) may be further held securely in place by the addition of, for example, magnetic or mechanical connections.

Before a test is conducted, all electronic components such as the imaging camera (18) and laptop (20) are switched on and made ready for use.

Once the imaging camera (18) is switched on, it is to be made ready for use. In this embodiment, an optical imaging camera (18) is used. For this to be made ready, the lens is focused onto the filter member (6), and this may be done either manually or automatically. The imaging camera (18) is zoom-adjusted to ensure the required portion of the filter member (6) is within the field of view.

The top cover (14) acts as a support for the imaging camera (18) in this embodiment, and may assist in preventing movement or vibrations, when in use. Occasional calibration may need to be conducted on the imaging camera (18) before beginning the test in order to ensure calculations of values by the software are accurate.

FIG. 3 illustrates the use of the apparatus (1) as part of the method of invention. For ease of visibility, the upper structure (3) is not shown in FIG. 3.

As shown in FIG. 3, the reservoir (8) in this embodiment is situated on the surface of the filter member (6) with an edge running parallel and close to the edge of the filter member (6).

As shown in FIG. 3, liquid is transferred into the reservoir (8) via a separate vessel (24). The liquid may be poured (continuous or batch operational mode) directly into the reservoir (8). In this embodiment, the apparatus (1) is in the open position as shown in FIG. 2. As indicated in FIGS. 1 and 2, when the top section 3 is in a closed position, liquid may be poured or added to the reservoir (8) via the pipe (16). Liquid may enter the reservoir (8) by passing through the pipe (16), which aids the user in the transfer of liquid from the vessel (24) to the reservoir (8) without incurring spillages. The pipe (16) is mechanically fixed in the top cover (14) such that it passes directly into the top of the reservoir (8) during the rotation of the top section (3) from an open to closed position. The pipe (16) may be removed once liquid has been transferred into the reservoir (8). Structural elements (e.g., pipe and reservoir) that are in contact with the liquid might require regular cleaning.

As shown in FIG. 3, once liquid has been transferred into the reservoir (8), a liquid front may begin to advance across the filter member (6) away from the reservoir (8) towards position (7) predominantly by means of capillary action. As the contact points between the filter member (6) and the reservoir (8) consist of straight edges, for this embodiment, a substantially linear liquid front advances across the filter member (6) towards position (7). The liquid front will advance continuously within the filter member (6) towards position (7), then onto positions (7′) and (7″). The velocity of the advancing liquid front and the distance travelled is dependent on multiple factors, including the properties of both the filter member (6) and the liquid used. Variables such as temperature, humidity and pressure may be controlled to allow for stable and reliable readings.

The optical imaging camera (18) records one or more images of the filter member (6) and/or liquid during operation. In the embodiment, more than one image is recorded. The first of these images may be recorded at any time including during movement of the liquid through the filter member (6), with further images being recorded throughout the test. These images will contain, in the field of view, a proportion of the filter member (6), as previously specified. In the schematic shown in FIG. 3, the imaging camera (18) may have, for example, a field of view extending between positions (7) and (7″) on the filter member (6). A larger field of view covering a larger area of the filter member (6) may allow for more data to be collected and for more accurate and reliable results to be produced. As the advancing liquid front approaches position (7) on the filter member (6), the imaging camera (18) will begin to record images. The recording of images is initiated automatically from either the laptop (20) or the imaging camera (18). Images will be recorded from the liquid front entering the field of view at position 7, and cease being recorded after the liquid front has passed beyond the range of the field of view after position (7″). This will ensure data are collected over the maximum displacement range of the liquid front possible.

All images recorded by the imaging camera (18) will be transferred to the laptop (20) and/or any other connected electronic devices connected via the USB hub (22). Analysis of the data is then conducted by a dedicated software, resulting in estimation values for one or more characteristics of the liquid. The use of visual image data in this method allows for far more data points to be used than by applying the previous CST apparatus and methods. Furthermore, the analysis of visual image data allows for more characteristics of the liquid to be calculated, which were not previously possible. For example, deceleration of the liquid with respect to time and displacement could not be calculated using previous test equipments and associated methods, but may be calculated with ease using the present invention.

The values calculated for the one or more characteristics of the fluid can then be automatically presented numerically, graphically or otherwise on either the laptop or any other connected electronic device.

The above embodiments are described by way of example only. Many variations are possible without departing from the scope of the invention as defined in the appended claims.

1. An apparatus for determining the values of one or more characteristics of a liquid, comprising support means for supporting a filter member in use, a reservoir for holding a sample of liquid in direct or indirect contact with the filter member in use and at least one device operable to record one or more images of the filter member and/or liquid, to record the value of one or more characteristics of a liquid moving through the filter member in use.

2. An apparatus as claimed in claim 1, wherein the or each device is operable to receive one or more images of the filter member and/or liquid comprises a visual imaging device.

3. An apparatus as claimed in claim 2, wherein the visual imaging device is a camera.

4. An apparatus as claimed in claim 1 comprising at least two devices that are operable to record one or more images of the filter member and/or liquid.

5. An apparatus as claimed in claim 1, wherein the reservoir is located at or towards an edge of the filter member.

6. An apparatus as claimed in claim 1, wherein the reservoir includes a liquid outlet located above a portion of an attached filter member in use.

7. An apparatus as claimed in claim 4 comprising at least two devices operable to record one or more images of the filter member and/or liquid; each device being operable to record images at the same or different time periods.

8. An apparatus as claimed in claim 1 wherein the support means comprise a light source, operable to illuminate at least a portion of the filter member.

9. An apparatus as claimed in claim 1 wherein the reservoir is located at or in the region of one of the edges of the support means.

10. An apparatus as claimed in claim 1, wherein the or each device operable to record one or more images of the filter member and/or liquid is connected to a computer or electronic computing device.

11. A method for determining the value of one or more characteristics of a liquid, wherein the method comprises the steps a) placing a sample of liquid in contact with a filter member to create an advancing liquid front through the filter member; b) imaging the advancing liquid; and c) using the or each image to record the value of one or more characteristics of the liquid.

12. A method as claimed in claim 11 comprising placing a sample of liquid in a reservoir above at least a portion of the filter member, and ejecting liquid from the reservoir onto the filter member.

13. A method as claimed in claim 11 wherein the liquid forms an advancing liquid front through the filter member.

14. A method as claimed in claim 11 wherein an image or images are recorded of the liquid at defined time periods.

15. A method as claimed in claim 11 wherein an image or images are recorded of the liquid continuously as the liquid advances.

16. A method as claimed claim 11 wherein the image or images recorded are transferred to a computer or other electronic computing device.

17. A method as claimed in claim 16 wherein the transferred image or images are analysed and quantitative or qualitative data are extracted.

18. A method as claimed in claim 17 wherein the data extracted are used to produce values for one or more characteristics of the fluid.

19. (canceled)

20. An apparatus or method as claimed in claim 1 wherein the or each characteristic of the liquid is selected from velocity, acceleration, deceleration, change in speed, distance travelled along the filter member, turbidity, light absorption, light reflectance, light transmission, colour change or distance travelled per unit time.
